(19) United States
(12) Patent Application Publication
(10) Pub. No.: US 2012/0095845 A1
(43) Pub. Date: Apr. 19, 2012

(54) Method and system for distributed marketing displays on highway signage

(75) Inventor: Daniel Shani, Newton, MA (US)

(73) Assignee: Vertical Ground, LLC, Newton, MA (US)

(21) Appl. No.: 13/136,687

(22) Filed: Aug. 8, 2011

Related U.S. Application Data
(60) Provisional application No. 61/401,427, filed on Aug. 11, 2010.

(51) Int. Cl. G06Q 30/02

(52) U.S. Cl. 705/14.71; 705/14.4

(57) ABSTRACT

Marketing communications are delivered by advertising displays affixed to or surrounding highway signage, e.g., bridges, tunnels, and road signs. Lease arrangements are determined by a machine-based method providing equitable revenue sharing among governmental entities owning the highway signage and advertising bidders and the marketing communication entity while providing rapid, reliable deployment to advertisers via a machine-based method of RFID tracking and deployment.

### PRIOR APPLICATION

This present application claims under 35 U.S.C. 119(e) the benefit of the prior filing date of Application No. 61/401,427 filed on Aug. 11, 2010.

### REFERENCES CITED

U.S. PATENT DOCUMENTS

| | | Issue/Publication | U.S. |
|---|---|---|---|
| Number | Inventors | Date | Classification |
| 4,453,325 | Ofsowitz et al. | June 1984 | 40/333 |
| 4,742,630 | Scumaci | May 1988 | 40/333 |
| 4,872,149 | Speas | October 1989 | 368/90 |
| 5,943,653 | Ross et al. | August 1999 | 705/14 |
| 2006/0213102 | Keach | September 2006 | 40/624 |
| 7,292,559 | Yoshimo and Shimizu | November 2007 | 370/338 |
| 2010/0010887 | Karlin and Wang | January 2010 | 440/9 |
| 2010/0211491 | Kagan et al. | August 2010 | 705/34 |

### TECHNICAL FIELD

The present invention relates generally to display advertising, including digital display advertising. More particularly, the present invention relates to displaying advertising messages on structures affixed to or surrounding highway structures in an outdoor context.

### BACKGROUND

Advertisers are keenly interested in generating the most consumer attention to their products and services as possible. These companies invest tremendous resources in identifying and categorizing consumer interests in order to create effective advertising messages. By using outdoor digital display advertising one can reach consumers in multiple high-value locations that current technology cannot reach. In addition, by using digital techniques, including holographic techniques, in such advertising one can reach a larger audience and create a more engaging customer experience.

Firstly, conventional means of displaying advertising messages are limited in terms of location. One example of this is that of highway billboards, which are limited as to where they can be placed, by the need to apply paint and to erect them in such locations as the side of highways. Also, conventionally, billboards are one-dimensional and can pose a safety risk as viewers must look off-road to see the messages. Moreover, the consumer experience is not especially engaging. Multiple chances to reach consumers are lost as conventional advertising techniques cannot be successfully applied in many areas where consumers are located. A related problem with such conventional display advertising is that it is limited in size and shape. The size and shape limitations of conventional display advertising restrict where it can be installed and how effectively it can project an image.

Secondly, conventional display advertising requires significant maintenance and repair and takes considerable time to install and to replace. Thus valuable time that could be used to display additional advertising is taken up with maintaining signage, repairing signage, installing signage, and replacing signage.

Thirdly, the conventional approach to display advertising misses multiple opportunities to reach consumers in centrally located, highly visible places. Conventional advertising impressions reach consumers only for a limited time. The present invention does not have such a “short-lived touchpoint”. One of the problems with the conventional approach is that drivers must look away from the road to see billboards hundreds of feet from the road and this leads many drivers to ignore display advertising adjacent to highways.

Fourthly, the conventional approach to display advertising is problematic in that there is no easy way to track signage status except by sending a crew to inspect the installation. Such a limitation is due in part to the static and one-dimensional nature of conventional display advertising. In addition, no added functionality, such as solar panels, traffic sensors, temperature sensors, or weather sensors, is included in a conventional installation of display advertising. The present invention has added marketing communication value and functionality and can collect and transmit onsite operational data. The present invention can be engineered to be safer than conventional display advertising and creates a more engaging consumer experience.

Accordingly, what is needed is the ability to install digital display advertising in more centrally located, highly visible places to attract more consumer attention to the advertisers' message. Further, it is desirable to include additional functionality in display advertising installations. Moreover, via RFID technology, it is desirable to track such installations, e.g., the status of each installation. Such status information rapidly shows which installations are not operational and for what diagnostic reason. Moreover, it is useful to know what is being displayed at each installation and for what amount of time each advertising message has been shown at each location. On digital displays, advertising messages could be changed via a wireless network. The combination of digital advertising displays, magnets, holographic technology, and RFID technology and their joint application in the field of display advertising for highway signage is novel.

### SUMMARY

According to a preferred embodiment, by installing additional functionality during the construction of a display advertising location, it would be possible to power, for example using solar panels, any attached LEDs, to display weather conditions, to display temperature conditions, to display road conditions, to display traffic conditions using CCD sensors; moreover it would be possible to, via RFID sensors and associated software, track the status of the display advertising installations and update the messages. By adding greater value and multiple dimensions to existing structures, it is demonstrable that the present invention is malleable and adaptable to multiple environments. All of the additional functionalities are novel applications to existing structures and demonstrate that the present invention can be adapted to multiple environments and can meet many needs. The invention can take advantage of existing structures, e.g., highway structures, such as bridges, tunnels, road signs, and so constitutes an environmentally green invention. The invention can be used on the opposite side of highway signage to reach travelers coming from the other direction. The invention is very sustainable: it does not need major construction of installations but rather efficiently makes use of existing resources, protects underlying structures from weathering and from corrosion, the process incorporates green, environmentally sustainable, materials and processes in the development, installation, and maintenance of signage. Moreover, there are additional features, which add value, such as solar power generation, data collection from signage and redistribution of that data via a software-driven process, and the ability to make real-time display adjustments at a given installation.

The details of one or more embodiments are set forth in the accompanying drawings and descriptions below. Other features, objects, and advantages will be apparent from the description and drawings.

### BRIEF DESCRIPTION OF THE DRAWINGS

FIG. 1. Cross Section of Marketing Display Sign

FIG. 2. Schematic Layout of Sensing System on Marketing Display Sign

FIG. 3. Schematic Layout of Sensing System Components

FIG. 4. Sensing System of Marketing Display Sign: Vertical Cross Section of CCD Camera

FIG. 5. Schematic Diagram of RFID Communication System

FIG. 6. Computer-based Method for Selection and Customization of Signage

FIG. 7. Marketing Communication Display: Non-divided Highway

FIG. 8. Marketing Communication Display: Divided Highway

FIG. 9. System For Conducting The Auction of Display Advertising Space Leases

### DETAILED DESCRIPTION OF THE PREFERRED EMBODIMENT

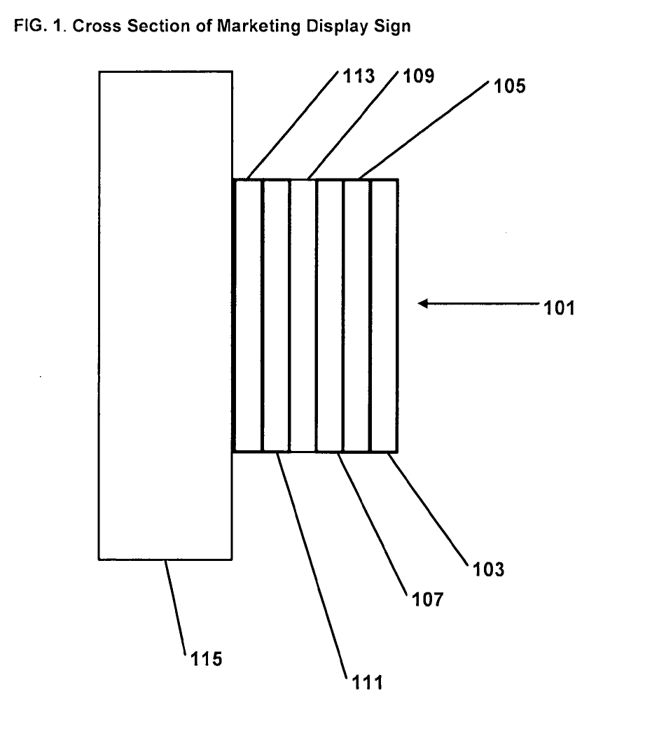

The present invention can be implemented in any polygonal shape and provides for display advertising employing a sign 101 with a plurality of layers as shown in FIG. 1. The portion labeled 113, the back protective layer of the advertising display, would be affixed by magnetic force to the metal surface 115 on which the magnetic display advertising is to be mounted and would protect the metal surface as well as the magnetic material from exposure to the corroding elements in the atmosphere. On this layer a reflective pigment or light-emitting diodes would be placed, as a bottom strip on the magnetic display advertising installation to be visible in the absence of strong natural light. The portion labeled 111 would be the magnetic layer in front of which in a portion of the sign would be the RFID sensors for use in the tracking system.

The portion labeled 109, the graphical layer of printed images or digital display, in front of the magnetic layer comprises, in the case of digital displays, a plurality of LEDs powered by an attached solar panel. Signage with a combination of digital and print images would also have LEDs powered by attached solar panels that store electricity in lithium ion batteries. Such a power source would allow the sign to continue to operate if there was a power failure in the area. The portions labeled 107, 105 are where a holographic or digital layer would be placed on the advertising image to allow changes with position of the observer. The portion labeled 103 would be the front protective layer protecting display materials from damage caused by natural elements. On the front surface portion of 101 a CCD camera would be placed to record weather and traffic conditions or other events of interest. Moreover, CCD cameras would be useful for security video surveillance to combat highway crime and violence. In addition, CCD cameras would count and monitor vehicular traffic.

It will be appreciated that terms such as “left”, “right”, “top”, “bottom”, “inwardly”, “outwardly”, “front”, “inner”, “up”, and “down” and other positional descriptive terms used hereinabove or hereinbelow are used merely for ease of description and refer to the orientation of the components as shown in the Figures. It should be understood that any orientation of the elements described herein is within the scope of the present invention. In addition, like numerals refer to like parts throughout the several views of the drawings.

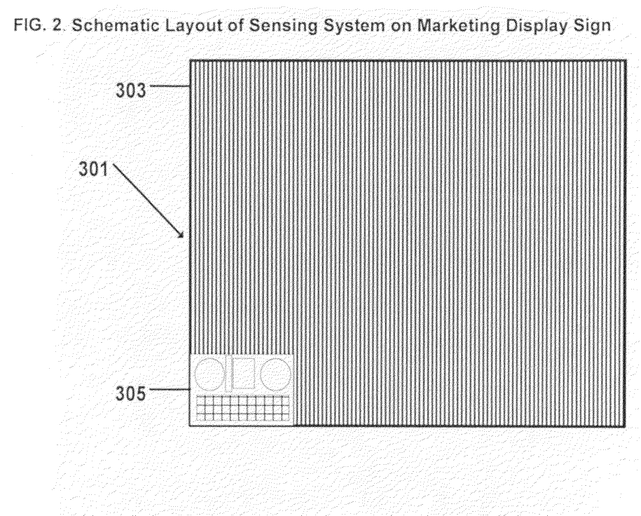

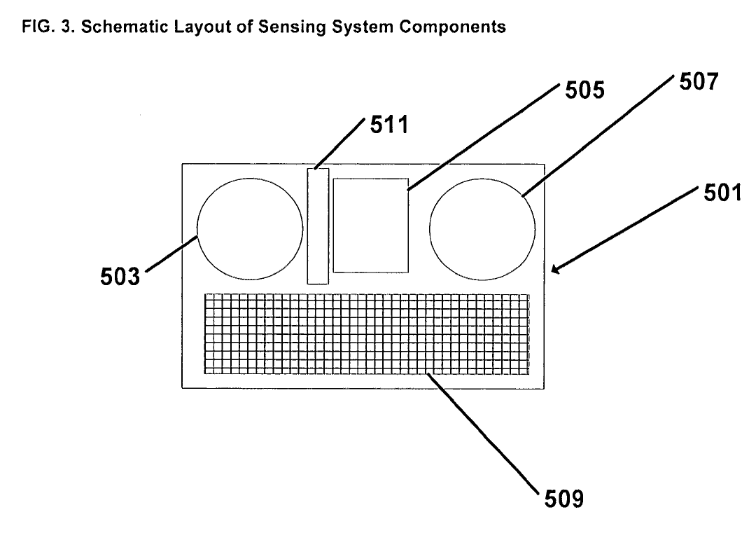

As shown in FIG. 2, the Marketing Display Sign 301 comprises at least one sensing system 305 embedded in the display advertising sign 303. Said sensing system as shown in FIG. 3 includes a weather sensor labeled 503 to detect the presence of high winds, rain, and snow and to detect how cold or hot the installation is at that moment in time, at least one CCD camera labeled 511 that can serve as a traffic sensor used to detect the volume of vehicles passing the sign per minute as a proxy for the number of viewers, and an active RFID sensor labeled 507 which detects the condition of the sign and, if there is a malfunction with the sign, detects what type of malfunction, e.g., freezing temperature, vandalism, some manner of vehicular accident, as well as which messages are being shown, and how recently said messages were installed at that location. Via a digital transmission system replacement advertising messages could be sent out to display advertising installations. The Sensing System 501 is powered by a solar panel 509 supplemented by a lithium ion battery 505. Moreover, the display system can use these power sources to illuminate the sign when visibility is poor, e.g., after sunset, on foggy days, and on cloudy days.

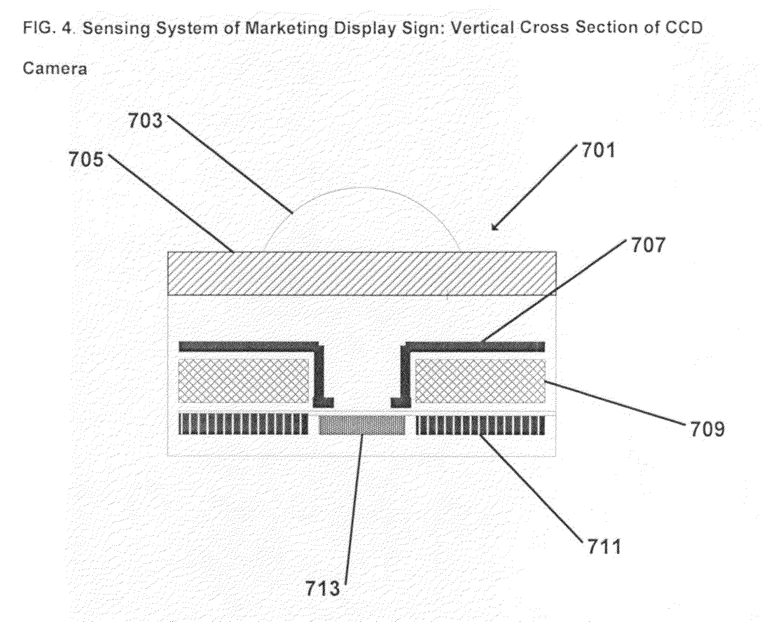

The CCD Camera 511 shown in FIG. 3 is depicted in vertical cross section in FIG. 4. A CCD Camera 701 is equipped with a microlens 703 in front of an optical filter 705. Images are focused by the microlens 703 onto the CCD sensor 713 with the stray or scatter light blocked by a photo-shielding film 707. Said camera system will be used to collect images that image processing software can recognize as vehicles that could serve as proxies for viewers, for example, to estimate delivered advertising display impressions.

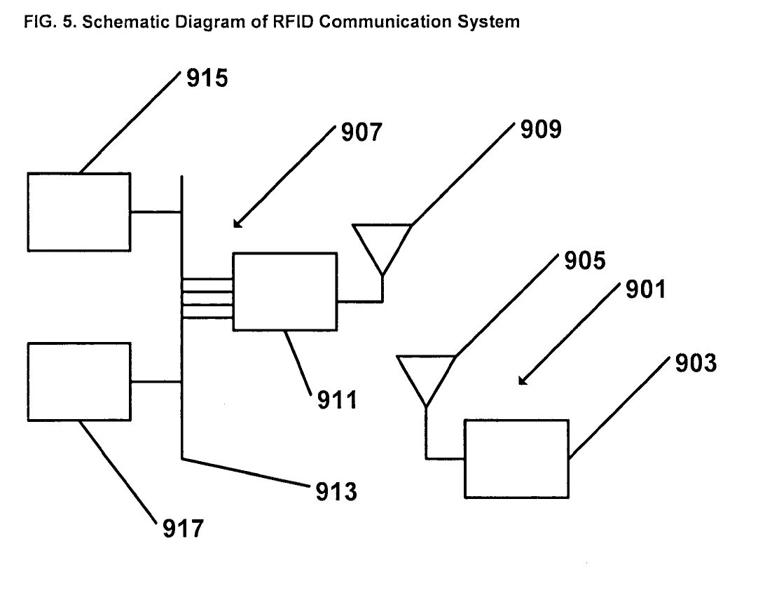

FIG. 5 illustrates the advertising display sign tracking system 901 comprising a network of servers 907 that receive input signals over a plurality of WiFi Access Points with RFID Readers 911 connected over a secure internet portal 909 from a plurality of active sensor systems connected to the secure internet portal. The active RFID sensor 903 would send signals to the position-tracking server 917 used by tracking software system 915 to track the installations of display advertising and monitor the operational status of each installation, e.g., the designation of the advertising content being shown in each location. The tracking system communicates alert messages when signage needs to be changed or an installation needs repair or maintenance. Moreover, new advertising messages in digital form or stored by digital reference could be sent to display advertising installations via this system. This computer system is used as part of a computer-based business method to track signs, i.e., to determine condition of signage, to determine which messages are being displayed at which installations, and to determine how long the messages have been displayed at each location. This system could also be used to update advertising messages based on information collected from signage. The component labeled 909 represents a web server that can access a global networking system such as the Internet. The portion labeled 915 represents a database server with display system database and associated applications. FIG. 5 is an illustration of the attached sensor and electronic devices that are included in magnetic display advertising. The portion labeled 903 is a RFID tag. Such tags enable a wireless network infrastructure to accurately track the location and condition of the display advertising installations. The RFID sensor is small, battery powered, and programmable. Such sensors send short 802.11b messages at predefined intervals to a wireless network. The sensors, which last for up to 5 years, can be mounted in many locations, are compact, are durable, and have the capacity to store and receive data messages. Each outdoor, magnetic, display advertising installation would have an ultralow power Wi-Fi-based tamper-proof active RFID tag. This RFID tag would be powered by one or more long-lasting rechargeable lithium batteries 505, on FIG. 3. Or the outdoor, magnetic, advertising installation could be powered by a solar panel, labeled 509 on FIG. 3, feeding into a rechargeable lithium battery. The RFID tags would monitor the environment and gather useful information, including, but not limited to, weather data, temperature data, traffic volume data, motion and condition of the signage data, as well as transmit location information via GPS.

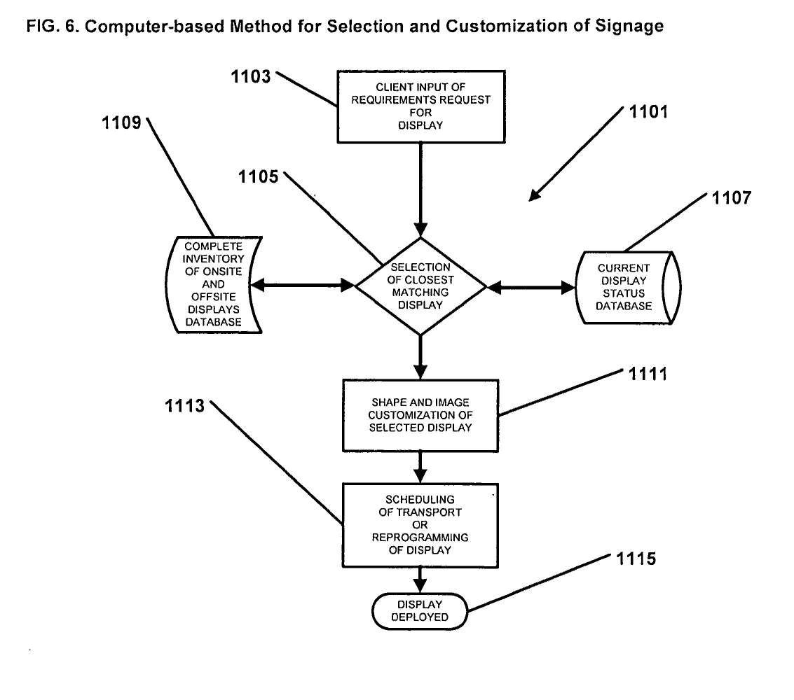

A computer-based system 1101 is used to optimize signage's dimensions, color, shape, lights, font size, pigment, and other aspects to best fit a given installation as shown in FIG. 6. This computer system is used as part of a machine-based business method to configure signs, i.e., locate the correct shape for a given installation in a database or, if said shape is not in the database, the software creates a printing master to optimally fit the space at the location. By thus optimizing the images so that they match the particular location of each installation greater marketing impact is achieved. The computer system would check inventory, on the database, labeled 1107, and on the distributed database cluster, labeled 1109, to determine if a suitably shaped magnetic advertising display already existed in the database. If no suitable shape was in the database, the computer system would configure the magnetic display advertising materials so as to fit the space at the proposed installation location optimally. The portion labeled 1103 represents a request from a plurality of clients. The portion labeled 1109 represents a database of shapes and signs in inventory; this database can be located centrally or be accessible via the Internet. The portion labeled 1107 represents a continually updated database of the status of deployed display systems. The portion labeled 1105 represents the decision module for determining the existence of a sign in the inventory and its current status in the field using the RFID tracking application. The portion labeled 1111 represents an application for customizing the shape of the advertisement to the available space at the location. The portion labeled 1113 represents the reprogramming of the display or scheduling of the transport of an existing sign to the required location. The portion labeled 1115 is the output indicating that the display has been deployed automatically over the Internet in the case of reprogramming an existing sign or a message dispatched to workers to redeploy a display system to a new location.

Municipal governments and state governments and the federal government own highway structures and such structures constitute locations where advertising displays could be located provided that satisfactory arrangements could be made with the entity owning the structure. The present invention provides a means for advertisers to lease display space. The machine-based business method arrives at a three-way mutually satisfactory display lease rate: satisfactory to the advertiser based on ROI or other measure; satisfactory to the owner of the highway structure, usually a governmental entity, based on the proportion of the revenues it receives, and satisfactory to the commercial entity arranging the leases and coordinating the displays based on the proportion of the lease fee they receive.

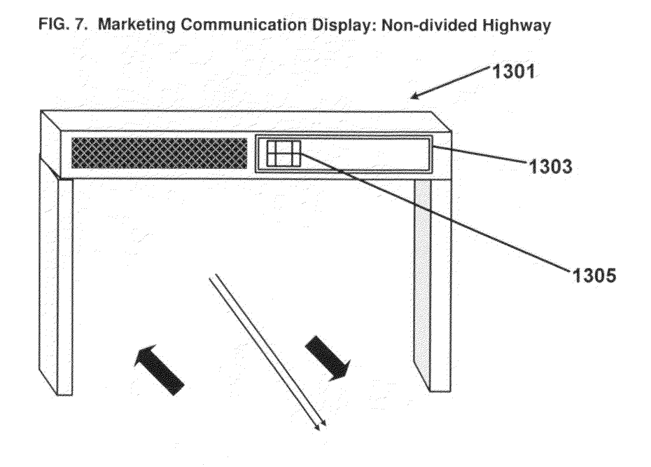

The present invention can be implemented in any polygonal shape such as that shown in FIG. 7. As shown in that figure the present invention provides for magnetic display advertising on undivided highways 1301 with a plurality of attachments. The portion labeled 1303, the advertising space on highway signage, would be the place on which the magnetic display advertising would be mounted thus protecting the metal surface as well as the magnetic material from exposure to the corroding elements in the atmosphere. Below the advertising space on highway signage 1303 would be placed the sensing and communication panel 1305, which is further shown in FIG. 3.

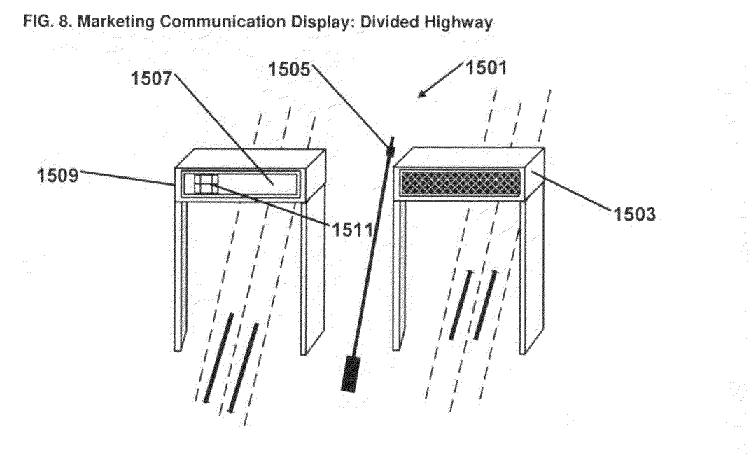

The present invention can be implemented in any polygonal shape such as that shown in FIG. 8. As shown in that figure the present invention provides for magnetic display advertising on divided highways 1501 with a plurality of attachments. The portion labeled 1503, the advertising space on highway signage, here shown on the north-facing side of the highway, would be the place on which the magnetic display advertising would be mounted thus protecting the metal surface as well as the magnetic material from exposure to the corroding elements in the atmosphere. The center line and dividing area of the highway is labeled 1505. The highway signage on the portion of the highway facing south is labeled 1507. The advertising space on the highway signage facing the opposite direction as the signage is labeled 1509. Below the advertising space on highway signage 1509 would be placed the sensing and communication panel 1511, which is further shown in FIG. 3.

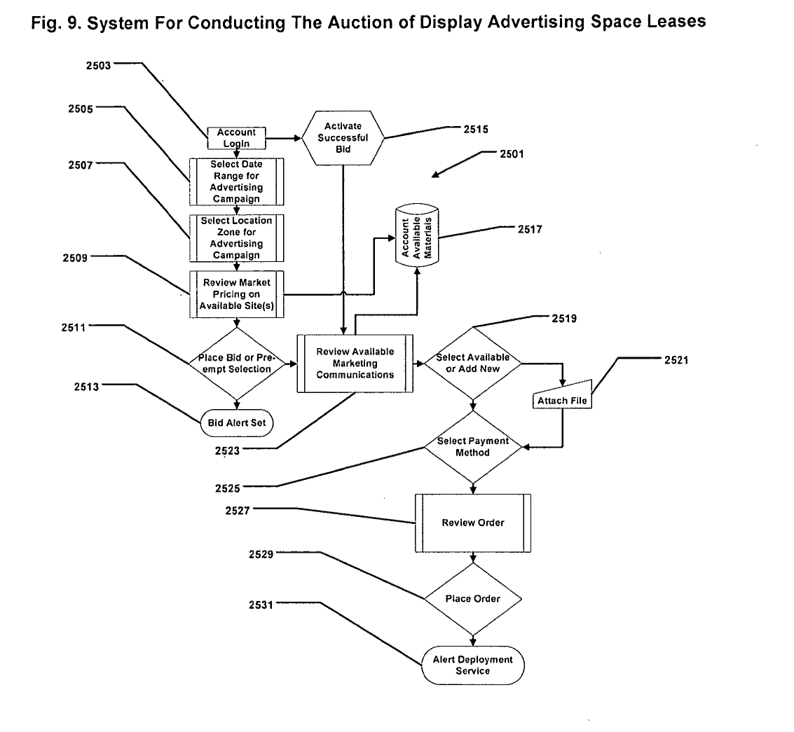

As shown in FIG. 9 represents the machine-based system or method of auctioning 2501 display advertising space leases affixed to or surrounding highway signage. Prospective advertisers would log onto the auction website to review and select locations, lease periods, and advertising materials. The computer system hosting the auction-based advertising display leasing market would function in the following manner. Interested bidders would have access via the website to review available sites, i.e., defined as available within a specified period. A computer-based transactional database of leaseable properties would inform the bidder of time left on each auction and of the current highest bid on each auction or of the reserve bid if there were no previous bids. The location database supports an interactive graphical user interface showing lease properties searchable by specific street addresses and by click-select from a map showing all the installations on a given street, district, or Metropolitan Statistical Area (MSA). The database would use maps and satellite technology, e.g., Google maps and GPS, to identify businesses near highway signage installations to let bidders know what surrounds the highway signage installations. The bidders would select proposed marketing communications from those in the database or attach new advertising messages in electronic form. If the advertiser was the highest bidder in at least one auction the marketing communication would be displayed for the contracted period at the contracted rate; however, the advertiser for a premium could preempt the auction to secure its desired locations and time periods. Said network comprises a login step 2503 for securing access to the auction website using a communication protocol such as SSL with two-factor authentication with digital tokens. After authentication the advertiser or its agent would specify a desired date range or ranges 2505 and a desired location or location(s) 2507 to review. Then the web-based interface would allow the advertiser to review available auctions that fit given parameters such as location, date range, and price 2509. After a review the advertiser would make a selection 2511 and chose to purchase time on a given display advertising installation or to bid in an auction or several auctions. A bid alert 2513 is set up in the database of the auction website. At this point if a bidder has entered a preemptive bid or subsequently won an auction a successful bid electronic message 2515 is sent to the bidder in question. The database of available marketing communications is represented by 2517. Available marketing communications 2523 are reviewed to determine if the desired marketing communication is within the available ones: if it is it is selected or if it is new it is added to the database 2519. At this point in the system or method the new file is attached 2521, then the payment method is selected 2525, then the order is reviewed by the user 2527, then an order is placed 2529, and finally the deployment system shown in FIG. 6 is alerted 2531. In addition, the auction server would be connected to the fee processing server which would send a portion of the winning bid to a bank server and send the remainder to the owner(s) of the highway signage space, e.g., a municipality's and/or state's and/or federal government's server, which would send it on to a bank server.

In a preferred embodiment, each installation is fitted with RFID sensors which send signals to a software system that tracks the installations of display advertising and monitors the operational status of each installation and what is being shown in each location and this software sends signals out when signage needs to be changed or an installation needs repair or maintenance. New advertising messages can be digitally transmitted to the display advertising locations via this software system.

An advantage of this type of display advertising is that the manufacturing process to create the magnetic strips on which advertising is placed would be environmentally sustainable. The process does not use adhesives and polluting chemicals to hold the display in place. Moreover, recycling of the magnetic strips and their reuse is possible. In addition, the manufacturing process used to create the non-conventional display advertising magnetic strips is environmentally friendly and the materials used in manufacturing and those used in printing and those used in distribution are also environmentally friendly.

An advantage of the above methods is that advertising can be placed in many more locations which are centrally located and highly visible, but which are currently not served. Moreover, the installations using preexisting structures need significantly less time to install compared to the prior art. Some installations could be instantaneous. Such installations have much lower costs and disrupt their surroundings significantly less than a comparable prior art installation. Another advantage of the above method is that advanced digital technology enables the advertising installations to collect and distribute valuable information. Moreover, the above method enables the tracking of signage for maintenance and repair and replacement purposes much more easily via RFID and a software tracking process. Still another advantage of the invention is that it can be solar powered via a flat solar generator on the end of the magnet to self-sustain lighting thus avoiding the need for a conventional power source. Moreover, additional functionalities such as traffic condition sensors, temperature condition sensors, and weather condition sensors can be displayed next to the advertising message.

Still another advantage of the new magnetic display advertising is that the structure on which it is placed is protected from corrosion and deterioration via special coatings and special materials. The new magnetic display advertising not only avoids the need to install additional structures, but it protects the outer surface of existing structures from exposure to corrosive elements. This minimizes maintenance costs associated with repainting and caring for highway signage.

The embodiments of the invention in which an exclusive property or privilege is claimed are defined as follows:

1. An apparatus surrounding or affixed to highway structures for displaying marketing communications, comprising at least one marketing communication module, further comprising a plurality of layers: a layer of digital display elements, a layer of magnetic material, a layer of holographic material and at least one sensing and communication module.

2. The apparatus of claim 1, wherein the sensory and communication module(s) comprises a weather sensor; at least one traffic sensor; and active RFID sensors to detect conditions at the installation.

3. The apparatus of claim 1, wherein the solar energy panel(s) is connected to electrical storage device(s) and is connected to light emitting diodes.

4. The apparatus of claim 1, wherein the marketing communication display comprises advertising messages deployed using holographic elements, light-emitting diodes, and graphical displays.

5. The apparatus of claim 1, wherein the material used to display the advertising comprises magnetic material, wherein RFID sensors are placed on the magnetic material, and an optical detection system.

6. The apparatus of claim 1, wherein the advertising images comprise holographic images to allow changes with respect to the position of the observer of the image; wherein a sensing system is used to record conditions at the installation; and Internet connectivity such that marketing communications can be transmitted to an installation and displayed.

7. A machine-based method for leasing highway structure space for advertising displays, the method comprising: an auction website; a login step for securing access to said website; and a database of available sites for display advertising searchable by date range and location, and viewable on a map of each display advertising installation.

8. The method of claim 7 wherein the user of the auction website could take a variety of actions, comprising: reviewing available auctions given parameters such as location, date range, and price; exercising the option to purchase time on a display advertising location immediately or to bid in the auction(s) by which action a bid alert would be sent to the auction website; and if successful in bidding a message would be sent to the winning bidder.

9. The method of claim 7 further comprising reviewing available marketing communications to determine if the desired marketing communication is in the database of marketing communications; if the desired marketing communication is within said database it is selected; and if the desired marketing communication is not in the database then there is the capability to add marketing communications in electronic form to said database.

10. The method of claim 7 further comprising attaching the new marketing communication file, selecting a payment method; and allowing the user to review the order.

11. The method of claim 7 further comprising placing an order, transmitting payment to the operator of the auction website; and further transmitting a portion of said payment to the govenmental owner of the highway structure on which the display advertising installation was placed.

12. The method of claim 7 further comprising transmitting a signal to the display advertising installations involved in a given auction when said auction is over; said transmission containing the time to start displaying the new marketing communication and the period to show the new marketing communication; and wherein the desired marketing communication is transmitted to the display advertising installations that were bid on during the auction from a marketing communication database.

13. The method of claim 7 further comprising transmitting a message(s) to an installation worker(s) to manually change the marketing communication display; receipt of signal from workers indicating completion of task; notification of bidding winner that marketing display is active.

14. A machine-based method for managing logistics of highway structure display inventory and deployment of said inventory and for optimizing the space of display advertising material to fit a given location and for transmitting data from a display advertising location to a central location and for transmitting data from said central location to display advertising locations, the method comprising: a database and distributed database cluster with records of all previously used marketing communications; software to optimize signage's dimensions, color, shape, lights, font size, pigment, and other aspects to a given location by creating a printing master; and means for said software to communicate with said database.

15. The method of claim 14, further comprising: configuring the magnetic display advertising, if necessary, so as to fit the space at the proposed installation optimally, receiving messages from installations via RFID as to the status of the deployed display systems, and, as needed, transmitting reprogramming to the deployed display systems or transmitting a signal to transport an existing sign to a required location.

16. The method of claim 14, further comprising: an output which indicated that a display's marketing communication has been deployed automatically over the Internet or that workers have been notified to redeploy a display system to a new location; a network of servers to receive input signals over a plurality of WiFi Access Points with RFID readers; and wherein said RFID readers are connected via a secure Internet portal to a plurality of active sensor systems.

17. The method of claim 14, further comprising: active RFID sensors that transmit signals to a position tracking server; a tracking software system to record the operational status of each display advertising installation, i.e., the marketing communications being shown and when each communication was first shown and how long it has been shown; and communication means to transmit alert messages when signage needs to be changed or repair or maintenance of an display advertising installation is needed.

18. The method of claim 14, further comprising: storage for new marketing communications in digital form or via digital reference; means to monitor display advertising installations; and a system to update marketing communications based on information collected from a given display advertising installation.

19. The method of claim 14, further comprising: a web server that can access a global networking system such as the Internet or World Wide Web, a database server with a display system database and associated applications; and RFID sensors which could track the location and condition of display advertising installations.

20. The method of claim 14, further comprising: weather sensors; temperature sensors; traffic volume sensors; condition of display advertising installation sensors; and means to transmit information via GPS.
